(19) United States
(12) Patent Application Publication
(10) Pub. No.: US 2004/0090029 A1
(43) Pub. Date: May 13, 2004

(54) Dolly

(75) Inventor: Douglas S. Hardesty, Barberton, OH (US)

Correspondence Address: HAHN LOESER & PARKS, LLP, TWIN OAKS ESTATE, 1225 W. MARKET STREET, AKRON, OH, 44313, US

(73) Assignee: Akro-Mils, A Division of Myers Industries Co.

(21) Appl. No.: 10/664,994

(22) Filed: Sep. 17, 2003

Related U.S. Application Data
(60) Provisional application No. 60/412,651, filed on Sep. 20, 2002.

(51) Int. Cl. B62B 1/00

(52) U.S. Cl. 280/79.11

(57) ABSTRACT

A dolly with removably attachable riser blocks in which the connectors for attaching the riser blocks to the upper surface of the dolly are separate and distinct from the connectors used to attach the casters on the lower surface of the dolly. The dolly is comprised of a plastic frame having a top surface, bottom surface, a pair of longitudinal side members and a pair of transverse side members intersecting to form corners of the frame, constituting a generally rectangular shape. A caster is attached to each corner on the bottom of the frame with fasteners. At least one riser block is removably attached to the top surface of the frame on at least one of the transverse side members. The riser block is attached with riser block fasteners that are separate from the fasteners used to attach the casters, providing a dolly with removable risers.

This application claims priority from provisional application serial No. 60/412651, filed Sep. 20, 2002, the disclosure of which is hereby incorporated by reference.

### BACKGROUND OF THE INVENTION

This invention relates generally to dollies and more particularly to an injected molded dolly assembled from either a single frame piece or two identical frame pieces.

Typically, dollies are made of relatively heavy, solid wood rectangles or wood slats with a caster fastened on the underside of each corner. In order to protect items transported on these dollies, it is often customary to provide raised ends that are covered with a protection device. Often the protective device is a rubber cap or carpeting. Usually, the carpeting or rubber caps are fastened to the wooden dollies using ordinary staples. However, since the wood used for dollies is usually of the hardwood variety, staples tend to fail to properly penetrate the wood. This causes the protective devices to loosen and exposes sharp staple ends that are hazardous to a user.

Recently, plastic dollies have been used. Plastic is preferable to wood for use as a dolly material. Plastic is easier to clean and is less dense than wood. Therefore, plastic dollies are lightweight and can be strengthened to be sufficiently sturdy. Plastic dollies are also often cheaper than wooden dollies and easier to manufacture. Plastic dollies usually need to be covered to protect items being transported. However, dollies made of plastic suffer disadvantages similar to wooden dollies in that it is very difficult to penetrate the plastic material with staples to secure protective coverings; other securing mechanisms must be used to protect the items being moved. Therefore, it is desirable to have a dolly that provides a means for easily attaching protective materials and components that wear out.

Furthermore, it is highly advantageous and desirable to construct dollies in a manner to facilitate disassembly for repair or replacement of various components of the dolly. This applies to both wooden and plastic dollies. To facilitate disassembly of the dolly, the protective devices should be readily removable. Plastic dollies that are easy to assemble and disassemble are also easier and cheaper to manufacture.

### SUMMARY OF THE INVENTION

The present invention is a plastic dolly having removable riser blocks. The dolly is comprised of a plastic frame having a top surface and a bottom surface. The frame having a pair of longitudinal side members and a pair of transverse side members intersecting to form corners of the frame, constituting a generally rectangular shape. The frame has a plurality of casters and a plurality of caster fasteners for securing a caster to the bottom surface of each corner of the frame. At least one riser block is removably positioned on the top surface of the frame on at least one of the transverse side members. The riser blocks are attached using a plurality of riser block fasteners separate from the fasteners used to attach the casters.

### BRIEF DESCRIPTION OF THE DRAWING FIGURES

FIG. 1 is a perspective view of a first embodiment of a two piece dolly according to the present invention;

FIG. 2 is a bottom view of the two piece dolly shown in FIG. 1;

FIG. 3 is a cross-sectional view of the two piece dolly shown in FIG. 1 showing the attachment of the casters to the two piece dolly;

FIG. 4 is an exploded perspective view of the two piece dolly shown in FIG. 1;

FIG. 5 is a bottom view of a second embodiment of a two piece dolly according to the present invention;

FIG. 6 is an exploded perspective view of the two piece dolly shown in FIG. 5;

FIG. 7 is an exploded perspective view of a one piece dolly with integral support pads; and

FIG. 8 is an exploded perspective view of a flat top surface one-piece dolly.

### DETAILED DESCRIPTION

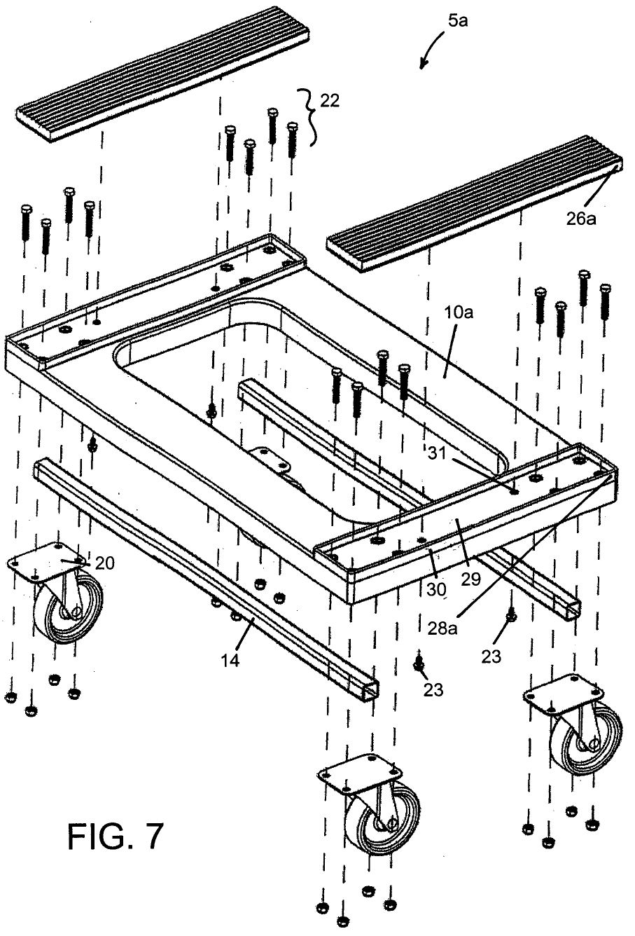

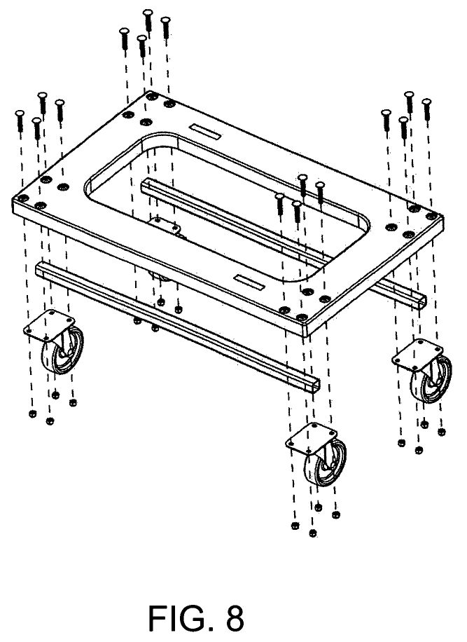

The first embodiment of the invention, shown in FIG. 7, provides a single piece frame. The frame can be made of sturdy HDPE industrial ribbed construction with dual tubular steel reinforcements to extend the maximum load to 1,000 lbs. FIG. 7 shows a one-piece dolly 5a having a frame 10a produced from a single unitary injection molded piece. The one-piece dolly 5a can be formed either as a one-piece flat dolly that does not include any riser pads 26a (See FIG. 8) or the dolly can be formed with a riser block retainer frame 30 integrally molded with one-piece dolly frame 10a, as shown in FIG. 7. Preferably riser block retainer frame 30 is molded simultaneously with one-piece frame 10a. Alternatively, one-piece frame 10a can be molded, then removed from a first mold, inserted into a second mold and then riser block retainer frame 30 is molded in place on one-piece frame 10a.

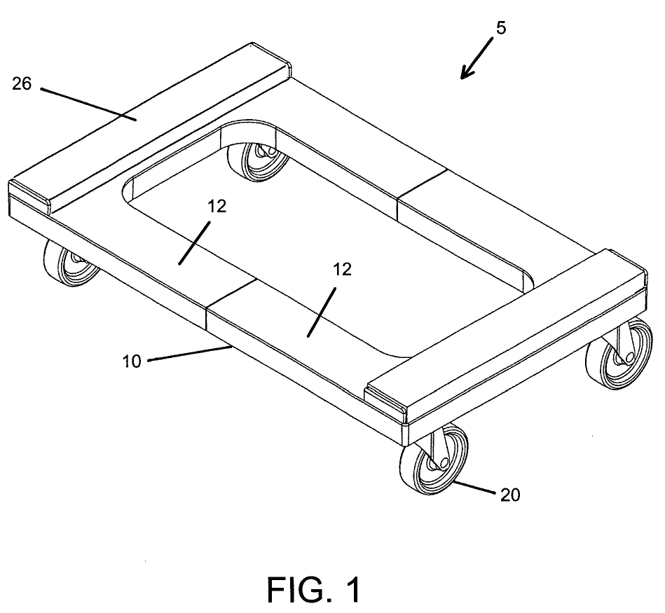

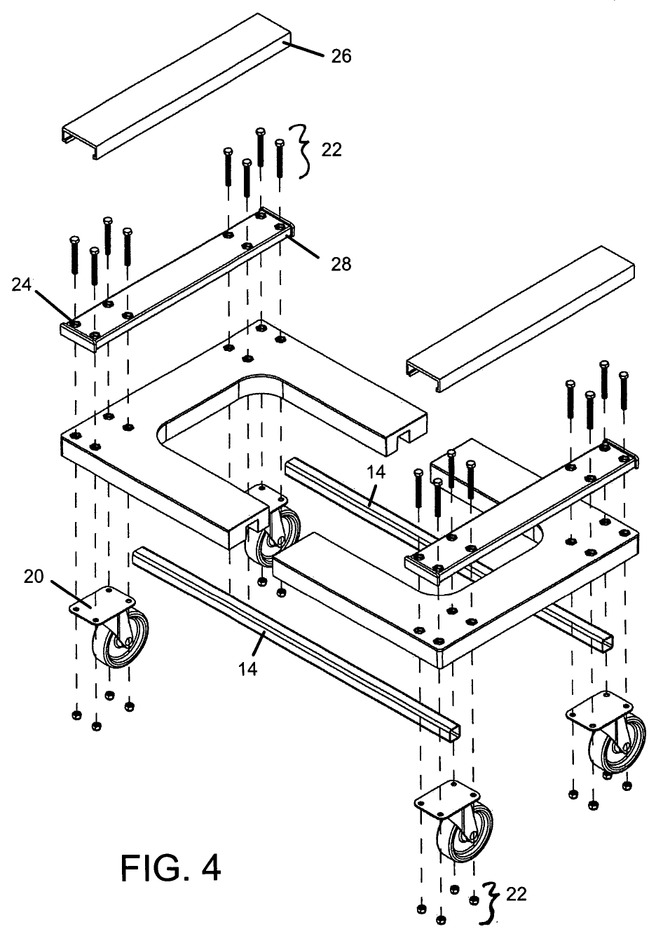

In one embodiment, riser block 28a includes a riser block retainer frame 30 on its top surface 29. A riser pad 26a is placed within riser block retainer frame 30 and attached to frame 10a with a plurality of riser block fasteners 23, separate from the fasteners 22 used to attach the casters. Similarly, riser block 28, and riser block covers 26 shown in FIGS. 1, 3, 4 and 6 can be attached by riser block fasteners 23 separate from the caster fasteners 22 used to attach the casters 20. In a preferred embodiment, as shown in FIG. 7, riser block 28a consists of riser block retainer frame 30 integrally molded with frame 10a. This embodiment allows a plurality of different types of riser pads 26a to be removably attached to the frame 10a. Riser pads 26a can be made of rubber, wood, plastic, fabric or a combination of materials where appropriate. Alternatively, riser block 28a can include a height raising portion (not shown) with riser block retainer frame 30 formed on its top surface 29. This embodiment would be used where it is desirable to increase the height of the riser pad 26a above the top surface of frame 10a. As another alternative, the thickness of riser pad 26a could be increased. In a further embodiment, the riser pad 26a may be attached to the top surface of the frame 10a without the use of the riser block retainer frame 30, and may be held in place by the plurality of riser block fasteners 23.

The dolly 5a with integral riser block retainer frame 30 may be constructed in several ways. One method includes providing a mold having a riser or frame cavity and blank for closing off the riser cavity. The blank would allow the dolly to be injection molded with or without the integral riser. When the blank is inserted into the mold, it closes off the riser cavity portion of the mold, creating a dolly with a completely flat top surface. When the blank is removed from the mold, a dolly that has a riser block retainer frame 30 for receiving the riser pad 26a as shown in FIG. 7 is created. Alternatively, a dolly which has a substantiality flat top surface could be created, having riser connector holes 31 integrated into the plastic frame 10, 10a for receiving fasteners 23 for attaching riser pads 26a to the top surface of the plastic frame.

The plastic dolly 5, 5a shown may have metal tubular reinforcement members 14 (channels) with rectangular shape (cross-section) extending approximately from end to end of the longest dimension of the frame 10, 10a. The metal tubular reinforcement members 14 are held in position on the ribbed side by the attachment of the casters 20 onto the plastic frame 10, 10a. Each metal tubular reinforcement member 14 is held in position at both ends.

The dolly 5, 5a also has swivel casters 20 having a plate style attachment method which are held into position on the ribbed bottom surface by the use of metal caster fasteners 22. In a preferred embodiment, a total of 16 fasteners are used to attach all 4-swivel casters 20 (4 fasteners per caster). The hexagon shape of the fastener head is preferably molded into the design of the caster fastening hole 24 on the plastic frame's 10 top surface to hold the fastener in position and to prevent rotation of the fastener when the product is being assembled.

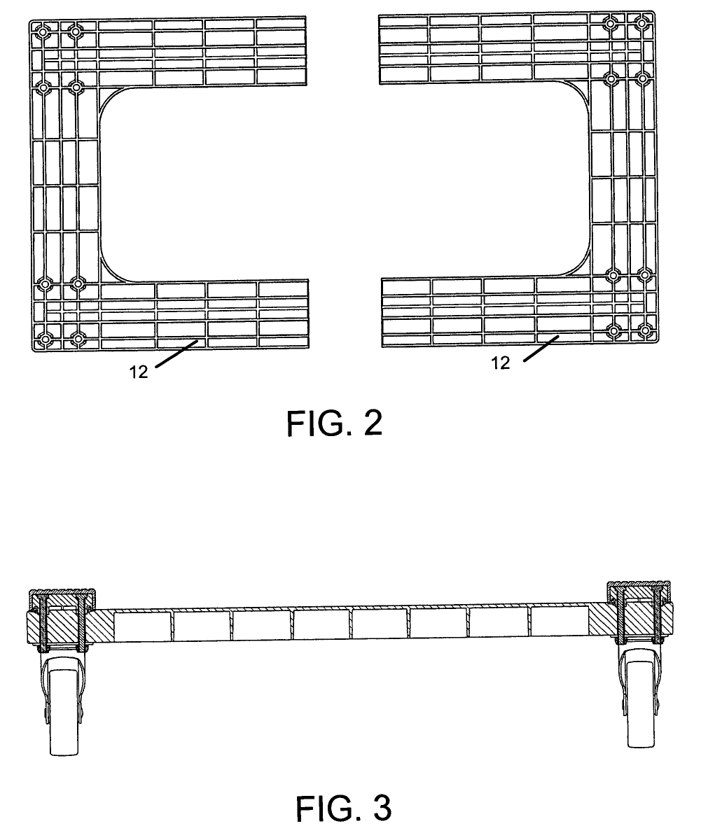

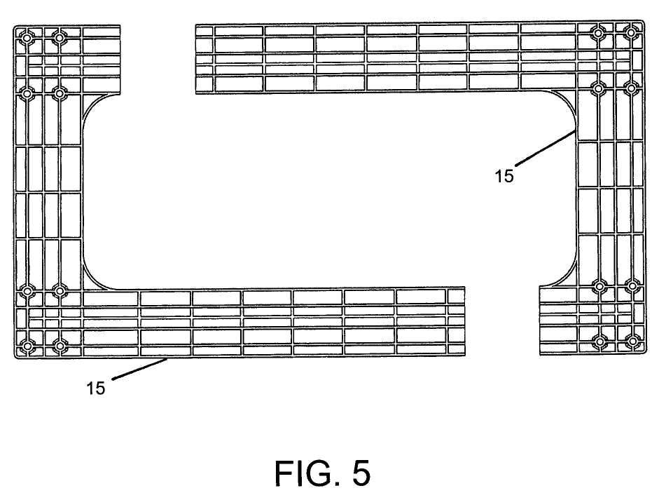

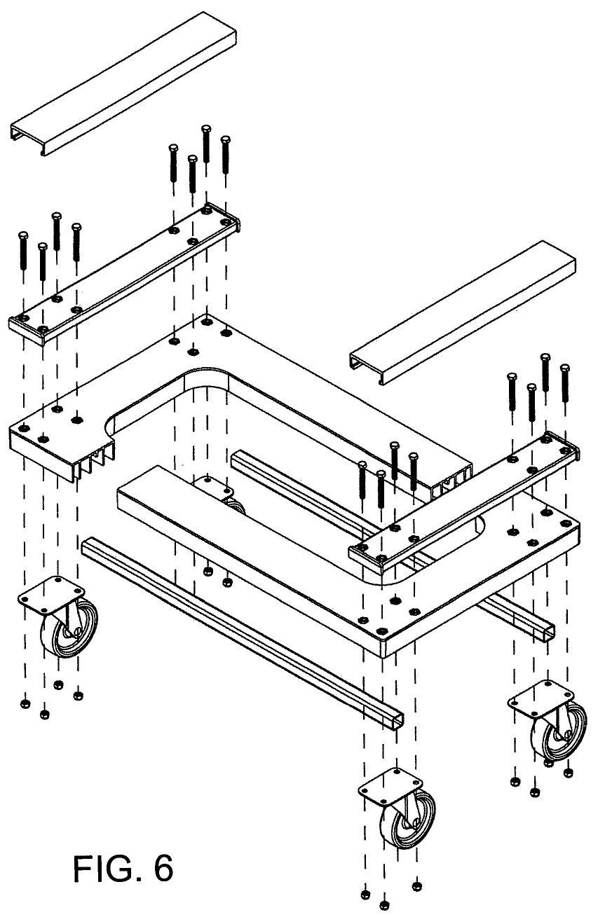

FIGS. 1, 2 and 4 show a second embodiment of a two-piece dolly 10 using U-shaped sections 12. FIGS. 5 and 6 show a third embodiment of the two-piece dolly using L-shaped sections 15. The attachment of casters 20 is similar for both embodiments and is shown in FIG. 3. The frame 10 can be made of sturdy HDPE industrial ribbed construction with dual tubular steel or metal reinforcements 14 to extend the maximum load to 1,000 lbs. This embodiment also provides a dolly that has an easily removable, protective riser block combination (28, 26 and 28a, 26a).

The two identical plastic injection molded U-shaped pieces 12 preferably connect together by means of a tongue & groove design that permits the two halves to join together and form a single one piece frame 10 for the dolly 5. The two identical plastic injection molded L-shaped pieces 15 connect together by means of an overlapping rabbet lap design that permits the two halves to join together and form a single one piece frame 10 for the dolly 5. However, the tongue and groove design could be use with the L-shaped sections 15 and the overlapping rabbet lap design could be used with the U-shaped sections 12.

The metal tubular reinforcement members 14 extend approximately from end to end of the longest dimension of the plastic frame 10 and are held into position on the ribbed or under side by the attachment of the casters 20 onto the plastic frame 10. Each metal tubular reinforcement member 14 is held in position at both ends by the casters 20.

The swivel casters 20 having a plate style attachment method are held into position on the ribbed bottom surface by the use of metal caster fasteners 22 (bolts and nuts.) A total of 16 fasteners are used to attach all 4-swivel casters 20 (4 fasteners per caster).

The hexagon shape of the caster fastening bolt head 22 is preferably molded into the design of caster fastening holes 24 on the plastic frame's 10 top surface to hold the bolt in position and to prevent rotation of the caster fastening bolt 22 when the product is being assembled.

The riser block 28 with riser covers 26 can be added to dolly 5, if additional protection is desired for fragile items. Otherwise, dolly 5 is provided as a flush frame. The riser covers 26 are extruded profiles that wrap around the riser block 28 that when joined together form a raised riser block for added protection of more fragile items. The riser covers 26 snap on the riser block 28 by friction force. Also, riser block 28 and riser covers 26 shown in FIGS. 1, 3, 4 and 6 can be attached by fasteners separate from the fasteners used to attach the casters. The riser block 28 could also be a one-piece design made of an elastomeric, wood or combination of materials that could be used in place of the combination two piece riser block 28 and riser cover 26 shown in the figures. Alternatively, the top surface of the plastic frame can also be textured to assist in preventing items from slipping off during movement and transportation.

In addition to the combination riser block 28a and riser pad 26a, shown in FIG. 7, the risers can be molded as a one-piece unitary member with frame 10a. Alternatively, male and female snap fittings could be formed in riser pad 26a and frame 10a respectively to permit the riser pad 26a to be snap fitted to frame 10a. Another alternative includes a keyed fitting and slot where riser pad 26a and frame 10a have a key and slot respectively where the riser pad 26a has a key that fits into a slot on frame 10a and then riser pad 26a is either rotated or move sideways to lock the key into the slot. In a further alternative, frame 10a has a pair of grooves and riser pad 26a has a rail or ridge that slides into the grooves. The rails and grooves should include a retention member that holds riser pad 26a in a fixed position on frame 10a once riser pad 26a has been slid to its final position.

Numerous characteristics, advantages, and embodiments of the invention have been described in detail in the foregoing description with reference to the accompanying drawings. However, the disclosure is illustrative only and the invention is not limited to the precise illustrated embodiments. Various changes and modifications may be effected therein by one skilled in the art without departing from the scope or spirit of the invention.

I claim:

1. A dolly comprising:
a generally rectangular plastic frame having a top surface and a bottom surface, said frame having a pair of longitudinal side members and a pair of transverse side members intersecting to form corners of the frame and constituting a generally rectangular shape;
a plurality of casters, each positioned at one of said corners of said frame;
a plurality of caster fasteners attaching said plurality of casters to the bottom surface of said frame at said corners;
at least one riser block removably attached on said top surface of said frame on at least one of said transverse side members; and
a plurality of riser block fasteners separate from said plurality of caster fasteners, wherein said plurality of riser block fasteners attach said at least one riser block to the top surface of said frame.

2. A dolly according to claim 1, further comprising:
at least one riser block retainer, said at least one riser block retainer being positioned on the top surface of said plastic frame along at least one of said transverse side members and said at least one riser block retainer having a cavity in which said at least one riser block fits, holding said at least one riser block in place.

3. A dolly according to claim 2, wherein said at least one riser block retainer is monolithic with the top surface of said plastic frame.

4. A dolly according to claim 1, wherein said at least one riser block is made of an elastomeric material.

5. A dolly according to claim 1, wherein said plurality of riser block fasteners are threaded fasteners.

6. A dolly according to claim 1, wherein said transverse side members having a length less than the length of said longitudinal side members.

7. A dolly according to claim 1, further comprising a riser block cover removably attached to said at least one riser block.

8. A dolly according to claim 7, wherein said riser block cover is a fabric, metal, wood or elastomeric material.

9. A dolly comprising:
a plastic frame;
a plurality of casters attached to the frame;
riser blocks removably attached to a top surface of the frame; and
a plurality of connectors attaching the plurality of casters and the riser blocks to the frame, a first portion of the plurality of connectors attaching only the casters to the frame, a second portion of the plurality of connectors attaching only the riser blocks to the frame, the second portion of the plurality of connectors being separate and distinct from the first portion of the plurality of connectors.

10. A dolly according to claim 9, further comprising,
at least one riser block retainer, said at least one riser block retainer being positioned on the top surface of said plastic frame, said at least one riser block retainer having a cavity in which one riser block fits, holding the one riser block in place.

11. A dolly according to claim 10, wherein said at least one riser block retainer is monolithic with the top surface of said plastic frame.

12. A dolly according to claim 9 wherein said riser blocks are made of an elastomeric material.

13. A dolly according to claim 9, wherein said plurality of connectors are threaded fasteners.

14. A dolly comprising:
a generally rectangular plastic frame having a top surface and a bottom surface, the frame having a pair of longitudinal side members and a pair of transverse side members intersecting to form corners of the frame and constituting a generally rectangular shape;
a plurality of casters attached to the frame;
elastomeric riser blocks removably attached to the top surface of the frame;
a plurality of connectors attaching the plurality of casters and the riser blocks to the frame, a first portion of the plurality of connectors attaching only the casters to the frame, a second portion of the plurality of connectors are threaded fasteners attaching only the riser blocks to the frame, the second portion of the plurality of connectors being separate and distinct from the first portion of the plurality of connectors; and
riser block retainers, the riser block retainers being monolithic with the top surface of the frame, each riser block retainer having a cavity in which one riser block fits, holding the one riser block in place.
